(19) United States
(12) Patent Application Publication
(10) Pub. No.: US 2024/0382905 A1
(43) Pub. Date: Nov. 21, 2024

(54) SURFACE-MODIFIED POLYMERIC MEMBRANES AND METHOD OF MAKING THEREOF

(71) Applicant: 3M INNOVATIVE PROPERTIES COMPANY, St. Paul, MN (US)

(72) Inventors: Pierre-Alexandre BOURGEOIS, Essen (DE); Sven N. FROST, Essen (DE); Tom OPSTAL, Kalken (BE); Jutta MAY, Wuppertal (DE)

(21) Appl. No.: 18/557,842

(22) PCT Filed: Apr. 5, 2022
(86) PCT No.: PCT/IB2022/053174

§ 371 Date: Oct. 27, 2023

Related U.S. Application Data
(60) Provisional application No. 63/181,755, filed on Apr. 29, 2021.

(51) Int. Cl. B01D 67/00; B01D 69/02; B01D 69/12; B01D 71/26; B01D 71/56

(52) U.S. Cl. CPC B01D 67/00931; B01D 67/009; B01D 69/02; B01D 69/12; B01D 71/261; B01D 71/56; B01D 2323/02; B01D 2323/385; B01D 2325/36

(57) ABSTRACT

A polymeric membrane. The polymeric membrane includes a modified surface obtained from coating with hydrophilic monomers and curing the hydrophilic monomers with electron beam, wherein the polymeric membrane is selected from polyamide membranes and Ultra-high-molecular-weight polyethylene (UHMWPE) membranes; and wherein the hydrophilic monomers comprise at least one amino moiety; at least one polyoxyalkylene unit; and at least one (meth)acrylate moiety.

### BACKGROUND

Polymeric membranes, for example, polyethersulfone (PES) or polyamide membranes are widely used in industry as base material for micro-and ultrafiltration materials. However, the scope and duration of the application of a certain current membrane may be limited. There is a need for a better polymeric membrane. In addition, polyamide membranes and ultra-high-molecular-weight polyethylene (UHMWPE) membranes have been used in industry for filtration processes. Polyamide membranes and UHMWPE membranes can be fouled by protein contaminants. Protein fouling of membranes reduces membrane performance. There is a need for new membranes with new properties to reduce membrane fouling.

### SUMMARY

Thus, in one aspect, the present disclosure provides a polymeric membrane, comprising a modified surface obtained from coating with hydrophilic monomers and curing the hydrophilic monomers with electron beam, wherein the polymeric membrane is selected from polyamide membranes, polytetrafluoroethylene membranes, polymethylpentene membranes and Ultra-high-molecular-weight polyethylene (UHMWPE) membranes; and wherein the hydrophilic monomers comprise
(i) at least one amino moiety;
(ii) at least one polyoxyalkylene unit; and
(iii) at least one (meth)acrylate moiety.

In another aspect, the present disclosure provides a method, the method comprising:
(I) providing a polymeric membrane selected from polyamide membranes, polytetrafluoroethylene membranes, polymethylpentene membranes and Ultra-high-molecular-weight polyethylene (UHMWPE) membranes;
(II) applying a solution comprising hydrophilic monomers to the polymeric membrane; and
(III) irradiating the polymeric membrane with electron beam,
   wherein the hydrophilic monomers comprise
(i) at least one amino moiety;
(ii) at least one polyoxyalkylene unit; and
(iii) at least one (meth)acrylate moiety.

In another aspect, the present disclosure provides a use of the polymeric membrane of present application, for water purification, filtration in the production of food, filtration in the production of beverages, filtration in the electronics industry, medical filtration or filtration in the biopharmaceutical industry.

Various aspects and advantages of exemplary embodiments of the present disclosure have been summarized. The above Summary is not intended to describe each illustrated embodiment or every implementation of the present disclosure. Further features and advantages are disclosed in the embodiments that follow. The Drawings and the Detailed Description that follow more particularly exemplify certain embodiments using the principles disclosed herein.

### DETAILED DESCRIPTION

Before any embodiments of the present disclosure are explained in detail, it is understood that the invention is not limited in its application to the details of use, construction, and the arrangement of components set forth in the following description. The invention is capable of other embodiments and of being practiced or of being carried out in various ways that will become apparent to a person of ordinary skill in the art upon reading the present disclosure. Also, it is understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. It is understood that other embodiments may be utilized and structural or logical changes may be made without departing from the scope of the present disclosure.

Amounts of ingredients of a composition may be indicated by % by weight (or “% wt”. or “wt.-%”) unless specified otherwise. The amounts of all ingredients gives 100% wt unless specified otherwise. If the amounts of ingredients are identified by % mole the amount of all ingredients gives 100% mole unless specified otherwise.

Unless explicitly indicated, all preferred ranges and embodiments may be combined freely.

Parameters as described herein may be determined as described in detail in the experimental section.

The present disclosure provides a polymeric membrane, comprising a modified surface obtained from coating with hydrophilic monomers and curing the hydrophilic monomers with electron beam, wherein the hydrophilic monomers comprise
(i) at least one amino moiety;
(ii) at least one polyoxyalkylene unit; and
(iii) at least one (meth)acrylate moiety.

This structure, i.e. the modified surface obtained from the hydrophilic monomers as described herein, leads to a combination of features desirable for a number of polymeric membranes, in particular with respect to their intended applications. In particular, the polymeric membranes are provided with a stable hydrophilic surface. This has the effect that a low protein adsorption is achieved, which is very advantageous for filtration of aqueous media. This includes microfiltration and nanofiltration purposes. This may be the case for applications in which protein containing solutions or dispersions are being filtered. These applications may comprise filtration of beverages or filtration in pharmaceutical or biopharmaceutical as well as medical applications.

Generally, the membranes according to the present disclosure are porous polymeric membranes selected from polyamide membranes, polytetrafluoroethylene (PTFE) membranes, polymethylpentene (PMP) membranes and Ultra-high-molecular-weight polyethylene (UHMWPE) membranes. Membranes selected from these materials generally exhibit desirable properties such as mechanical stability, chemical resistance as well as easy manufacturing according to processes well-established in the art. The polyamides normally used for polyamide membranes are suitable for use as the polyamide constituting the membrane of the present disclosure or as the polyamide used in the method of the present disclosure. Thus, polyamide homopolymers like polyamide-6, polyamide-6,6, polyamide-6,1 or polyamide-4,6, polyamide-11 or polyamide-12, and also polyamide copolymers such as those based on polyamide-6,12 can be used. The number average molecular weight of the polyamides used in the method of the invention lies preferably between 20000 and 60000 Daltons. Polyamides of this type show a relative solution viscosity (SV) of between 2.5 and 5. Additionally, in the context of the present invention, polyamides of high thermal stability are preferred, which allow superheated steam sterilisation of the polyamide membrane formed from them at temperatures of at least 130° C. without any change in the membrane structure. For the present invention, polyamide-6 is especially preferred as the polymer constituting the membrane. Examples of commercially available polyamide-6 include the Ultramid series (from BASF, Ludwigshafen) such as Utramid B40LN and AKULON F 136E (from DSM).

Ultra-high-molecular-weight polyethylene (UHMWPE) membranes can be prepared as described U.S. Pat. No. 4,778,601 “Microporous Membranes of Ultrahigh Molecular Weight Polyethylene” (Lopatin), which is herein incorporated by reference in its entirety. Generally, UHMWPE membranes are formed from a resin having a molecular weight from about 500,000 Daltons to about 8,000,000 Dalton. Examples of commercially available ultra-high-molecular-weight-polyethylene include the GUR-Type (from Ticona) and Lupolen UHM 5000 (from Basell).

The polymeric membranes as described herein have a first and a second surface and a wall extending between the first and second surface as well as pores on the first and second surfaces and throughout the wall. Thus, the polymeric membranes are preferably porous membranes and can either be flat sheet membranes or hollow-fibre membranes. Preferably, the membranes according to the present disclosure are flat sheet membranes.

The membranes according to the present disclosure comprise a modified surface. The modified surface is obtained coating the aforementioned membrane with hydrophilic monomers and curing said hydrophilic monomers with electron beam.

Preferably, the at least one polyoxyalkylene unit of the hydrophilic monomers as used herein is selected from polyethers. Polyethers exhibit good chemical stability for the purposes envisaged herein and do usually not exhibit significant environmental or health concerns. A preferred example for polyether units is the category of polyethylene glycols (PEG).

The hydrophilic monomers according to the present disclosure comprise at least one amino moiety. This gives rise to a certain hydrophilicity of the monomer itself, but also to the coating obtained therefrom. With regard to the at least one amino moiety, it is preferred that it is at least one secondary amino moiety and/or at least one tertiary amino moiety. Secondary and tertiary amino moieties are both chemically stable enough for the purposes envisaged herein. They also exhibit a reduced nucleophilicity compared to primary amino moieties (due to steric reasons), and are only susceptible to some extent to differing pH-values when immersing the coating obtained from the monomers in aqueous solutions. Preferably, the hydrophilic monomer as described herein comprises at least one secondary amino moiety. In this regard, it is preferred that the hydrophilic monomer comprises one secondary amino moiety, two secondary amino moieties, three secondary amino moieties, or four secondary amino moieties. It is also preferred that the monomer comprises at least one tertiary amino moiety. Preferably, the monomer comprises one tertiary amino moiety, two tertiary amino moieties, three tertiary amino moieties, or four tertiary amino moieties.

In some embodiments, the hydrophilic monomer has at least two secondary amino moieties, at least three secondary amino moieties, at least two tertiary amino moieties, or at least three tertiary amino moieties. In some embodiments, the hydrophilic monomer has two secondary amino moieties, three secondary amino moieties, two tertiary amino moieties, or three tertiary amino moieties.

The hydrophilic monomer according to the present disclosure comprises at least one (meth)acrylate moiety. This presence of at least one (meth)acrylate moiety has the advantage that the hydrophilic monomer as disclosed herein may be easily polymerized or coated onto a variety of substrates by means of well-established techniques such as heating or by means of actinic irradiation. Preferably, the hydrophilic monomer comprises (meth)acrylate moieties in an amount of from 1 to 10, preferably from 1 to 8, more preferably from 1 to 6. (Meth)acrylate moieties in these amounts give rise to advantages such as good crosslinking properties, without compromising the chemical and mechanical stability of the coatings. That is, the (meth)acrylate moieties may be selected from methacrylate moieties and acrylate moieties, of which acrylate moieties are preferred due to their better performance. Preferably, the hydrophilic monomer comprises acrylate moieties in an amount of from 1 to 10, preferably from 1 to 8, more preferably from 1 to 6.

In some embodiments, the hydrophilic monomer has 2, 3, 4, 5, 6, 7, or 8 (meth)acrylate moieties. In some embodiments, the hydrophilic monomer has 2, 3, or 4 (meth)acrylate moieties.

The hydrophilic monomers according to the present disclosure can include those described in International Application Number PCT/IB2020/060393. Preferably, the hydrophilic monomer according to the present disclosure is a monomer according to any one of formulae (I), (II), (III), (IV), (V), (VI), (VII), or (VIII)1

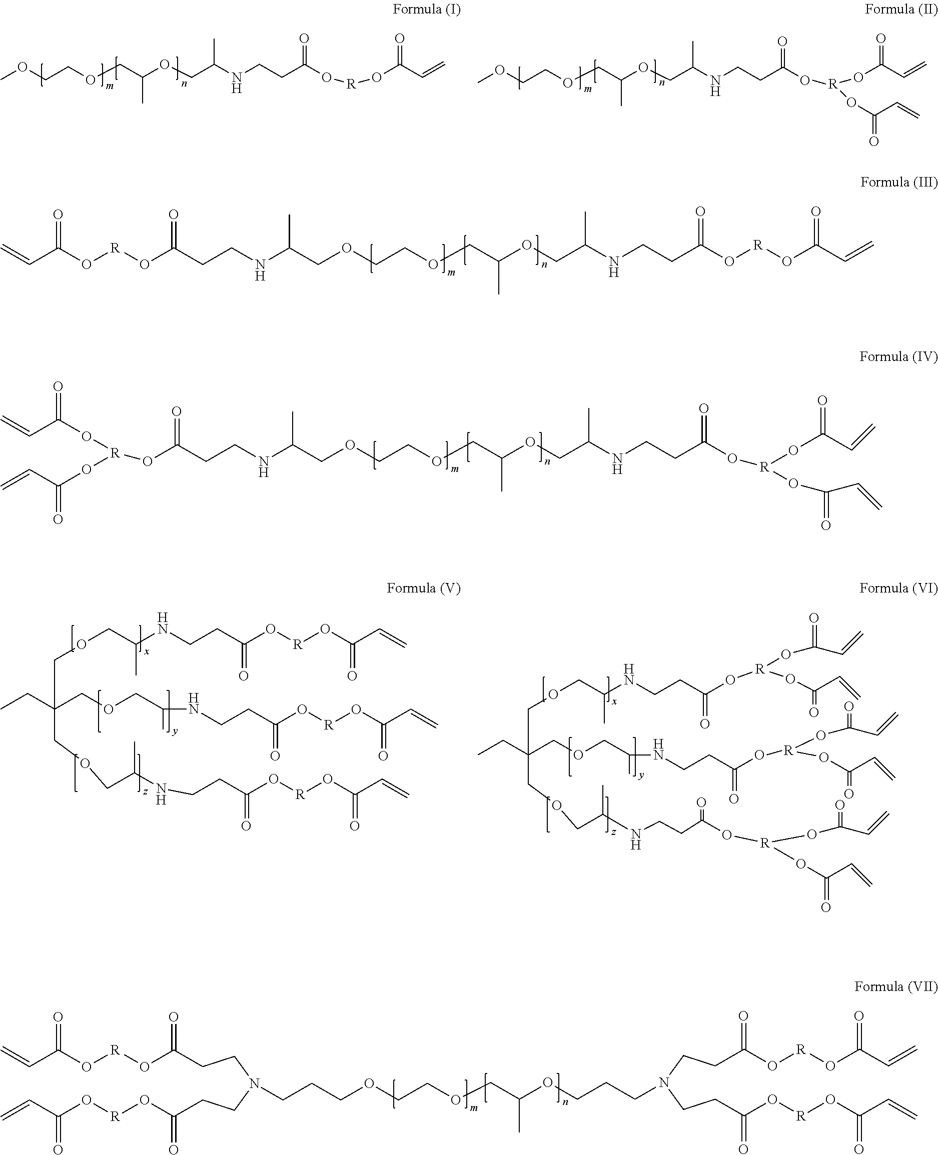

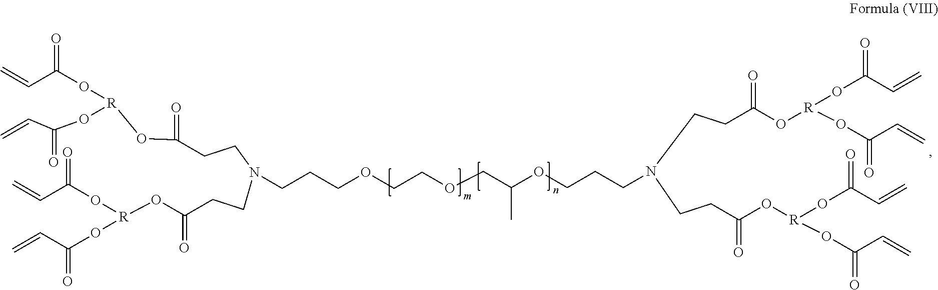

wherein m an n may be different or the same, wherein m and n may each be in a range of from 0 to 100, wherein x, y and z may be different or the same, and may be in the range of from 1 to 100, wherein R is an organic residue, preferably selected from linear or branched alkyl or alkoxy residues. Preferably, m is in the range of from 1 to 70, more preferably from 1 to 50. Similarly, it is preferred that n is in the range of from 1 to 70, more preferably from 1 to 50. X is preferably in the range of from 1 to 70, more preferably from 1 to 50. Y is preferably in the range of from 1 to 70, more preferably from 1 to 50. Z is preferably in the range of from 1 to 70, more preferably from 1 to 50.
It is also preferred that wherein the hydrophilic monomer according to the present disclosure is a monomer according to any one of formulae (IX to XIV)

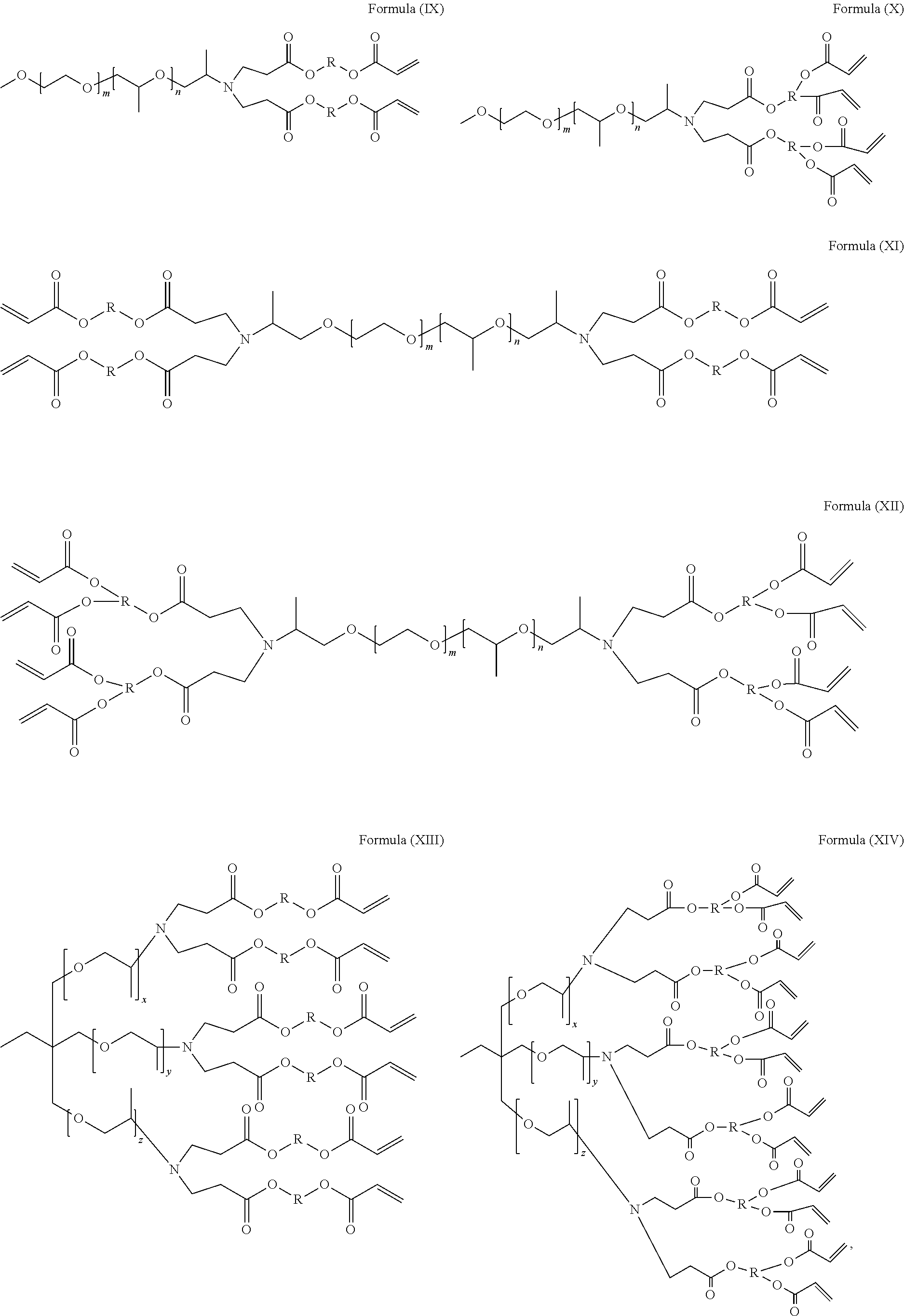

wherein m an n may be different or the same, wherein x, y and z may be different or the same, wherein m and n may each be in a range of from 1 to 100. and wherein R is an organic residue, preferably from linear or branched alkyl or alkoxy. Preferably, m is in the range of from 1 to 70, more preferably from 1 to 50. Similarly, it is preferred that n is in the range of from 1 to 70, more preferably from 1 to 50. X is preferably in the range of from 1 to 70, more preferably from 1 to 50. Y is preferably in the range of from 1 to 70, more preferably from 1 to 50. Z is preferably in the range of from 1 to 70, more preferably from 1 to 50.

In some embodiments of the Formulas (I), (II), (III), (IV), (VII), (VIII), (IX), (X), (XI), and (XII), m is from 1-200 and n is zero. In some embodiments of the Formulas (I), (II), (III), (IV), (VII), (VIII), (IX), (X), (XI), and (XII), m is zero and n is from 1-200.

In some embodiments of the Formulas (I), (II), (III), (IV), (VII), (VIII), (IX), (X), (XI), and (XII), m is from 1-100 and n is zero. In some embodiments of the Formulas (I), (II), (III), (IV), (VII), (VIII), (IX), (X), (XI), and (XII), m is zero and n is from 1-100.

In some embodiments of the Formulas (I), (II), (III), (IV), (VII), (VIII), (IX), (X), (XI), and (XII), the sum of m and n is from 1-70. In some embodiments of the Formulas (I), (II), (III), (IV), (VII), (VIII), (IX), (X), (XI), and (XII), m is zero and n is from the sum of m and n is from 1-50.

In some embodiments of the Formulas (I)-(XIV), R is a linear or branched alkyl or alkoxy moiety having 2-40, 2-20, 2-12, or 2-8 carbon atoms. In some embodiments of the Formulas (I)-(XIV), R is a linear or branched alkyl moiety having 2-40, 2-20, 2-12, or 2-8 carbon atoms.

In some embodiments of the Formulas (I), (III), (V), (VII), (IX), (XI), and (XIII). R can be —(CH₂CH₂)p- wherein p is 2-20, 2-12, or 2-8.

The hydrophilic monomer according to the present disclosure is preferably obtained from reacting at least one polyoxyalkylamine with at least one (meth)acrylate compound. Preferably, the at least one polyoxyalkylamine is selected from polyetheramines. It is preferred that the at least one polyoxyalkylamine, preferably the at least one polyetheramine, comprises ethoxy-units and propyloxy-units. In this regard, it is preferred that the polyoxyalkylamine, preferably the at least one polyetheramine comprises at least 5 ethoxy-units, preferably at least 10 ethoxy-units, and more preferably at least 12 ethoxy-units. It is also preferred that the polyoxyalkylamine, preferably the at least one polyetheramine, comprises less than 25 propyloxy-units, preferably less than 20 propyloxy-units, and more preferably less than 15 propyloxy-units. Preferably, the ratio of ethoxy-units to propyloxy-units is in the range of from 1 to 20, preferably from 1 to 15, and more preferably from 1 to 10. It is also preferred that the at last one polyoxyalkylamine, preferably the at least one polyetheramine, exhibits a molecular weight of at least 80 Dalton, preferably at least 100 Dalton, more preferably at least 200 Dalton. Preferably, that the at last one polyoxyalkylamine, preferably the at least one polyetheramine, exhibits a molecular weight of 8000 Dalton and less, preferably 7000 Dalton and less, and more preferably 6000 Dalton and less. Accordingly, it is preferred that the at last one polyoxyalkylamine, preferably the at least one polyetheramine, exhibits a molecular weight in the range of from 80 Dalton to 8000 Dalton, preferably from 100 Dalton to 7000 Dalton, and more preferably from 200 Dalton to 6000 Dalton. It is also preferred that the at last one polyoxyalkylamine, preferably the at least one polyetheramine, is either a monoamine, diamine, or triamine. Polyetheramines which may be advantageously used as the polyoxyalkylamine as described herein are commercially available e.g. from Huntsman under the tradename “Jeffamine®”. Examples for Jeffamines® are M1000, M2070, ED900 and T403.

The at least one (meth)acrylate compound is preferably selected from di(meth)acrylates, tri(meth)acrylates, tetra(meth)acrylates, penta(meth)acrylates, and hexa(meth)acrylates. Mono(meth)acrylates will not yield the hydrophilic monomers as disclosed herein. Preferably, the (meth)acrylate compound is selected from diacrylates, triacrylates, tetraacrylates, pentaacrylates, and hexaacrylates. In this regard, it is preferred that the at least one acrylate compound is selected from alkyldiacrylates, alkyltriacrylates, alkyltetraacrylates, alkylpentaacrylates, alkylhexaacrylates, polyethylene glycol diacrylates, ethoxylated trimethylolpropane triacrylates, and trimethylolpropane triacrylate. Preferably, the at least one acrylate compound is selected from polyethylene glycol diacrylates, preferably having between 2 and 20 ethoxy units. Diacrylates which may be advantageously used for the purposes described herein are commercially available, for example, from Sartomer-Arkema under the trade designations SR 259, SR 344 and SR 610. It is also preferred that the ethoxylated trimethylolpropane triacrylates comprise ethoxy units in an amount of from 4 to 25, preferably between 5 to 23, more preferably between 6 and 20. Examplary (ethoxylated) trimethylolpropane triacrylates for use herein may be obtained from Sakoma-Arkerna under the trade designation SR502 or SR9035 and from ECEM under the trade designation TMPEOTA.

The modified membrane according to the present disclosure is obtained from coating the membrane with the hydrophilic monomers as described herein and curing said monomers with electron beam. Using electron beam irradiation for curing the hydrophilic monomers has the advantage that much less energy is required for curing than for e.g. thermal curing. Furthermore, curing with electron beam is carried out at much lower temperatures than thermal curing. This is of particular importance as many polymeric materials used in polymeric membranes cannot withstand higher temperatures. Also, heating up to higher temperatures may already alter the delicate porous membrane structure, which is generally not desirable.

The modified surface of the polymeric membranes as disclosed herein may extend over the first and/or second surface, and over the walls and pores throughout the wall of at least 50%, preferably of at least 60%, more preferably of at least 70% and even more preferably of at least 80% of the thickness of the wall, starting from the first surface and/or the second surface. That is, the modified surface as described herein preferably does not only cover the first or second surface of the polymeric membrane, but also extends into the pores of the wall between those surfaces. This has the advantage that a larger part of the total surface of the porous membrane is covered by the modified surface. The larger the part of the total surface of the porous membrane is covered by the modified surface, the more pronounced the advantages with regard to increased hydrophilicity, decreased protein adsorption and decreased level of extractables of the membrane. Thus, it is preferred that the modified surface extends over the pores throughout the wall over a thickness of at least 50%, preferably of at least 60%, more preferably of at least 70% and even more preferably of at least 80% of the thickness of the wall, or of a thickness greater than 35 μm, preferably greater than 50 μm, more preferably greater than 75 μm, and even more preferably greater than 95 μm of the thickness of the wall, starting from the first surface and/or from the second surface. For example, in the case of a flat sheet membrane, the modified surface extends over the first surface and over the pores throughout the wall of at least 50%, preferably of at least 60%, more preferably of at least 70% and even more preferably of at least 80% of the thickness of the wall, or of at least 25 μm of the thickness of the wall, preferably greater than 35 μm, preferably greater than 50 μm, more preferably greater than 75 μm, and even more preferably greater than 95 μm of the thickness of the wall, starting from the first surface. In this regard, it is preferred that the modified surface extends over at least 5%, preferably at least 10%, more preferably at least 20%, and even more preferably at least 30% of the second surface. More preferably, the modified surface may extend over the first surface, over the pores throughout the complete thickness of the wall, and over at least part of the second surface of the wall. For example, in the case of a commonly used porous PES flat-sheet membrane having a thickness of about 110) μm, the modified surface may extend over the first and second surfaces as well as over the complete thickness of the wall extending between the first and second surfaces.

The modification of the surface may be identified by means of ATR-IR analysis. For example, the absorbance of the C═O stretch vibration (e.g. at 1725 cm⁻¹) representing the Polyetheramine(meth)acrylates on the membrane first and/or second surfaces may be detected. This may also be compared to a corresponding membrane without a modified surface. For instance, if a flat sheet membrane was modified by irradiating it from the side of the first surface, and ATR-IR detects that also the second surface or at least part of it has been modified, then it is evident that also the surfaces of the pores extending on the complete thickness of the wall between the first and second surfaces has been modified. Thus, ATR-IR detection represents a direct method for determination of modification of the first and second surfaces, and allows for an indirect determination of the extend of the modified surface of the pores in the wall between the first and second surfaces. In addition, modification of the surface as described herein may be determined via a combination of microtome and IR-microscopy.

The polymeric membranes as described herein have surfaces exhibiting hydrophilic properties. Preferably, the surface of the polymeric membranes as described herein exhibit a positive zeta-potential at pH-values of less than 5, preferably less than 6, and preferably less than 7. Similarly, it is preferred that the surface of the polymeric membrane as described herein exhibits an isoelectric point at a pH-value in the range of from 4 to 9, preferably from 4.5 to 8.5, more preferably from 5 to 8, more preferably from 6 to 8. This has the advantage that the hydrophilic surface properties of the polymeric membranes according to the present disclosure may be triggered by means of adjusting the pH-value of the aqueous media to be filtered. That is, for example, filtering certain elements from the aqueous media may be started or avoided by adjusting the pH-value of the aqueous media. This may be a particular advantage in the biopharmaceutical industry. Zeta-potential and isoelectric point as described herein are preferably determined as described in the experimental section. Also, it is preferred that the amount of IgG bound to the surface of the membrane is lower than, 150 μg/cm², 100 μg/cm², 75 μg/cm², 50 g/cm², 40 μg/cm², or 30 μg/cm². In some embodiments, the adsorption of IgG to the surface of the membrane is reduced by minimum a factor 3 compared to the polymeric membrane without the modification of hydrophilic monomers. This has the advantage that the polymeric membranes as described herein exhibit a very low tendency to adsorb proteins, even after exposure to extraction. The IgG-values as used herein are preferably determined as described in the experimental section of the present disclosure and can help obtaining a lower protein binding value of the polymeric membrane.

The hydrophilic polymer chains bound to the surface membrane lead to a decreased protein binding. The hydrophilic monomers modified polymeric membrane helps to obtain a lower protein binding value. In some embodiments, the polymeric membrane of present application can decrease the protein binding by a factor 3 to 8 compared to the polymeric membrane without the modification of hydrophilic monomers.

The polymeric membrane according to the present invention preferably exhibit a trans membrane flow for water of at least 0.01 mL/(cm²·min·bar), preferably at least 0.1 mL/(cm²·min·bar), more preferably at least 0.15 mL/(cm²·min·bar), and even more preferably at least 0.2 mL/(cm²·min·bar). This ensures an adequate and stable filtration capacity in the application. It is further preferred that the flat sheetmembranes as disclosed herein exhibit a trans membrane flow for water in the range of from 0.01 to 150 mL/(cm²·min·bar), preferably from 0.15 to 130 mL/(cm²·min·bar), and more preferably from 0.5 to 125 mL/(cm²·min·bar). Trans membrane flows in these ranges allow for adequate and stable filtration capacity in suitable applications without deteriorating the retention capacity or compromising the mechanical stability. The trans membrane flow is preferably determined as described in the experimental section.

The present disclosure further provides a process for producing a surface-modified polymeric membrane, comprising the following steps:
(I) Providing a polymeric membrane selected from polyamide membranes and Ultra-high-molecular-weight polyethylene (UHMWPE) membranes;
(II) Applying a solution comprising hydrophilic monomers to the polymeric membrane; and
(III) Irradiating the polymeric membrane with electron beam,
   wherein the hydrophilic monomers comprise
(i) at least one amino moiety;
(ii) at least one polyoxyalkylene unit; and
(iii) at least one (meth)acrylate moiety.

Therein, the hydrophilic monomers as disclosed herein for the polymeric membranes as described herein are used in the processes according to the present disclosure. This also applies for the polymeric membranes.

In step (III), irradiation with electron beam is carried out. This both cures the hydrophilic monomers, i.e. bonds between monomers are likely be formed, and grafts the hydrophilic monomers onto the surface of the polymeric membrane. Using electron beam may also have the effect that not only the surface of the membrane facing the source of irradiation is modified, rather, modification of the surface of the pores extends into the thickness of the membrane and even to the side facing away from the source of irradiation. As source of electron beam (or “e-beam” as commonly used) common e-beam apparatuses as conventionally used for these purposes may be employed in the processes as described herein. Electron beam irradiation may be carried out either directly or indirectly. Direct e-beam curing comprises applying a solution comprising the hydrophilic monomers to the polymeric membrane, or immersing the polymeric membrane in such a solution, and then irradiating the membrane covered together with the hydrophilic monomers with electron beam. Indirect e-beam irradiation comprises irradiating the polymeric membrane first, and then applying the solution comprising the hydrophilic monomers. In the latter case, it is believed that irradiating the polymeric membrane with electron beam generates radicals on the surface of the membrane, which then react with the (meth)acrylate moieties of the hydrophilic monomers, thereby effectively grafting the monomers onto the membrane surface. In this regard, it is preferred that electron beam irradiation (whether indirectly or directly as described herein) is carried out under an inert atmosphere. The term “inert atmosphere” as used herein denotes an atmosphere having a very low oxygen content. It is preferred that the oxygen content is below 30 ppm, more preferably below 25 ppm, and more preferably below 20 ppm. Higher oxygen contents may have the disadvantage that side reactions may occur due to the formation of oxygen radicals or of ozone by irradiation of oxygen molecules by electron beam.

Furthermore, it is preferred that irradiating with electron beam is carried out an irradiation dose of a mean value in the range of from 10 to 300 kGy, preferably from 20 to 280 kGy, and more preferably from 20 to 230 kGy. Lower doses were found to yield low surface modification and low weight gain ratios, which is undesirable for manufacturing on industrial scale. Low surface modification also translates in lower hydrophilicity and higher protein binding and may also yield higher extractables, which is also not desirable. On the other hand, while higher doses furnish more surface modification in terms of higher weight gain by grafted (meth)acrylate, this may also affect water permeability of the modified membrane. In addition, for higher doses, no further increase of hydrophilicity (i.e. decreased protein binding) may be found. The doses in the preferred ranges may be achieved by correspondingly actuating the source of irradiation. Alternatively, the membrane and the monomer solution applied thereto may be moved in relation to the source of irradiation at a certain constant speed. For example, the membrane may be placed onto a conveyor belt and then moved under a fixed electron beam generator at a certain speed, resulting in a certain residual time of the membrane under the electron beam generator and consequently in the desired dose. In this regard, the side of the membrane as described herein facing the irradiation source in the process according to the present disclosure may be called “first side”, the side of the membrane facing away the irradiation source may be called “second side” of the membrane. While it is preferred for practical reasons that irradiation is affected only onto one side of a membrane (i.e. the “first side”), irradiation may also be affected onto the other side of the membrane (i.e. the “second side”).

Preferably, the method according to the present disclosure comprises an additional step (IV) subjecting the membrane obtained in step (III) to an extracting step to remove residual solvents and additives. Preferably, this extracting step comprises subjecting the membrane to at least one extraction bath. For practical reason, it is preferred that at least one extraction bath comprises water even consists of water. Preferably, the at least one extraction bath may be at ambient temperature, but may also be tempered to a temperature in the range of 20 to 100° C., preferably in the range of from 25 to 100° C., more preferably in the range of from 30 to 100° C.

Similarly, it is preferred that the method as described herein comprises a further step (V) drying the membrane. Drying has the common meaning in the art, i.e. the removal of solvent, in particular water, from the membrane surfaces and/or the membrane pores. Preferably, drying in step (v) comprises exposing the membrane to air having a temperature in the range of from 25 to 120° C., preferably in the range of from 35 to 105° C., and more preferably in the range of from 45 to 95° C. Means and methods for drying membranes, in particular flat-sheet membranes by exposing the membrane to air having temperatures in the preferred ranges, are known in the art to the skilled person.

Using the hydrophilic monomers as described herein and irradiating the membrane with electron beam has the effect that the surface of the polymeric membrane gets modified, i.e. the monomers polymerize and/or get grafted onto the polymeric membrane surface. Formation of the modified surface gives rise to a certain weight gain of the membrane. This weight gain may be determined as described in the experimental section.

The solvent in the solution comprising the monomers as described herein preferably comprises water. Preferably, the solvent comprises water and may further comprise at least one further solvent. The at least one further solvent may be selected from the list consisting of alcohols such as methanol, ethanol and propanol (both iso-propanol and neopropanol) as well as butanol, pentanol and hexanol, halogenated solvents such as dichloromethane, ethers such as diethylether, esters such as ethylacetate and ketones such as acetone and butanone (methylethyl ketone). It is preferred that the solvent is water, preferably deionized water since this may yield the best reproducible results. Preferably, the solution contains the monomers in an amount of at least 1 wt.-%. Lower amounts would result in a slow weight gain during irradiation in the subsequent step, which is not desirable from a process economy in an industrial scale. It is also preferred that the solution contains the monomers in an amount of not higher than 20 wt.-%. Higher amounts may not necessarily lead to a higher weight gain, but may also lead to undesired side reactions. An adversary effect of using higher amounts may be, e.g., water permeation of the membrane reduced to low levels undesired or even unsuitable for many applications of the membrane. Moreover, it was found that above this amounts no further benefit with regard to protein binding properties of the modified membrane existed. In this regard, it is preferred that the solution contains the monomers in an amount in the range of from 0.5 to 20 wt.-%, preferably in the range of from 1 to 18 wt.-%, more preferably in the range of from 1 to 16 wt.-%.

“Applying the solution” comprising the monomers as described herein may be carried out by spraying the solution onto the membrane or immersing the membrane in a vessel containing the solution. In some embodiments, the vessel is a shallow vessel and is suitable for transmitting the actinic irradiation of corresponding wavelengths as described herein. In this regard, it is preferred that the vessel is shallow so that the membrane is immersed in the solution and covered by the solution containing the monomers. Diptrays and tablets are preferred examples.

Due to the unique combination of properties of the membranes as described herein, preferably obtained from the method as described herein, the present disclosure further provides a use of the membranes as described herein for filtration processes. This may involve microfiltration, nanofiltration or even ultrafiltration. “Microfiltration”, “Nanofiltration” and “ultrafiltration” have the meaning common in the art. Preferably, the use as described herein comprises water purification, filtration in the production of food, filtration in the production of beverages, filtration in the electronics industry, medical filtration and filtration in the biopharmaceutical industry. Preferred uses are hemodialysis, virus filtration, and sterile filtration. Also preferred uses comprise microfiltration sterilizing filters, ultrafiltration clearance filters, but also wine clarification, beer filtration, vinegar clarification, and potable water purification.

The following working examples are intended to be illustrative of the present disclosure and not limiting.

### EXAMPLES

Objects and advantages of this invention are further illustrated by the following examples, but the particular materials and amounts thereof recited in these examples, as well as other conditions and details, should not be construed to unduly limit this invention.

The materials used to prepare examples of the invention (Ex) as well as comparative examples (CE) are outlined below. The exemplary hydrophilic monomers according to the present disclosure are indicated by the designation “PEAA” followed by a number (for example “PEAA1”, “PEAA2”, etc.).

### Test Methods

### Transmembrane Flow (TMF) Assay

For polyamide membranes, TMF was measured using water. Disc-shaped membrane samples were stamped from the membrane and individually tested. Each disc was clamped fluid-tight at the perimeter in a suitable sample holder such that there was a free filtration area of 43.2 cm². The sample holder was located in a housing connected to a pressurized water system. The clamped membrane sample was oriented so that deionized water penetrated the membrane from the membrane surface with the smaller pores. The deionized water in the system was conditioned to 25° C. at a defined pressure between 0.1 and 0.2 bar. The amount of water volume that flowed through the membrane sample during a measuring period of 60 seconds was determined either gravimetrically or volumetrically.

For UHMWPE membranes, TMF was measured using isopropyl alcohol (IPA).

Disc-shaped membrane samples were stamped from the membrane and individually tested. Each disc was clamped fluid-tight at the perimeter in a suitable sample holder such that there was a filtration area of 17.35 cm². The sample holder was located in a housing connected to a pressurized isopropanol (IPA) system. The clamped membrane sample was oriented so that IPA penetrated the membrane from the membrane surface with the smaller pores. IPA was conditioned to 25° C. at a defined pressure 0.6 bar. The amount of IPA volume that flowed through the membrane sample during a measuring period of 2 minutes was determined either gravimetrically or volumetrically.

The transmembrane flow (TMF) for water or IPA was determined according to Equation 1.

$$TMF [ \frac{mL}{{cm}^{2} \cdot min \cdot bar} ] = \frac{{V}_{W}}{[ {A}_{M} \cdot Δ t \cdot Δ p ]} \qquad Equation 1$$

where:
Vw=volume of water or IPA (mL) flowing through the membrane sample during the measuring period
Δt=measuring time (minutes)
A_{M}=area of the membrane sample penetrated (43.2 cm² or 17.35 cm²)
Δp=pressure set during the measurement [bar]

### Percent Weight Gain

The weight gain of each sample after performing the grafting procedure was calculated according to Equation 2. The percent weight gain is reported as the mean value calculated from two separate tests (n=2).

$$\% Weight Gain = \frac{( Membrane weight after grafting - Membrane weight before grafting )}{Membrane Weight before grafting} \times 100 \qquad Equation 2$$

### Static Protein Binding Assay With IgG

Protein binding tests were conducted in phosphate buffered saline (PBS) solution (obtained from the Sigma Aldrich Company, St. Louis, MO) using the model protein IgG (from human blood, ≥99%, obtained from the Sigma Aldrich Co.) at pH 7.4. The membrane samples (circular discs, 1 cm in diameter) were placed in the wells of a 24-well microwell plate (one disc per well). The disc in each well was immersed in the IgG solution (concentration=4 g/L) and the plate was shaken for one hour using a benchtop orbital shaker. Next, the IgG solution was removed and the membrane discs were washed by adding PBS buffer (1 mL) to each well and shaking the plate for 10 minutes. The PBS wash solution was then removed and the wash procedure was repeated two times using fresh PBS for each wash step. The amount of IgG bound to the membrane surface (micrograms/cm²) was determined using a Pierce BCA protein assay kit (Thermo Fisher Scientific, Waltham, MA). The BCA assay contained bichincinonic acid and copper(II) sulfate. The reaction of the surface-bound protein with the copper(II) resulted in the formation of a distinct copper(I)-complex that was detected at 562 nm using an absorption reader (model ELx808, Bio-Tek Instruments, Winooski, VT).

### Zeta-Potential Measurement

Zeta-potential measurements were performed with the SurPASS Electrokinetic Analyzer System from Anton Paar GmbH (Graz, Austria). Prior to the measurement, each membrane sample was cut into two rectangular pieces (20 mm×10 mm) and attached to the two sample holders of the Adjustable Gap Cell (AGC) using double-sided adhesive tape. The streaming potential along the channel formed by the two membrane samples was measured using the AGC. The gap between the sample holders was adjusted to 0.1 micrometers. After filling the system with 10⁻³ mol/L potassium chloride solution, a pH titration was performed with 0.05 mol/L sodium hydroxide solution starting at pH 3 and continuing in a step-wise manner to pH 9. A step-wise pressure increase was performed at each pH value and the resulting streaming current was measured. The Zeta-potential was calculated according to Equation 3 (the Helmholtz-Smoluchowski equation).

$$ζ = \frac{DI}{DP} \times \frac{η \times L}{{ε}_{0} \times ε \times A} \qquad Equation 3$$

ζ is the Zeta potential, DI/DP is the slope of streaming current vs. pressure along the channel, η is the electrolyte viscosity, ε₀ is the vacuum permittivity, ε is the dielectric constant of the electrolyte, L is the length of the streaming channel and A is the cross-section of the streaming channel. The isoelectric point of the membrane sample was measured as the pH value at which the membrane surface carried no net electrical charge (zeta-potential equals 0 mV).

### Reagents and Materials

TABLE 1

| Designation | Description (Source) |
|---|---|
| BDDA | 1,4 Butanediol diacrylate, CAS No. 1070-70-8, (obtained |
| | as LAROMER BDDA from BASF SE, Ludwigshafen, Germany) |
| IRGACURE | Photoinitiator, (obtained from BASF SE) |
| 500 | |
| JEFFAMINE | Monofunctional polyetheramine with average MW |
| M1000 | about 1000 and PO/EO molar ratio of 3/19, |
| | (obtained from the Huntsman Corp., The Woodlands, TX) |
| JEFFAMINE | Monofunctional polyetheramine with average |
| M2070 | MW about 2000 and PO/EO molar ratio of 10/32 |
| | (obtained from the Huntsman Corp.) |
| JEFFAMINE | Difunctional polyetheramine with average MW |
| ED900 | about 900 and PO/EO molar ratio of 3.6/15.5, CAS |
| | No. 65605-36-9, (obtained from the Huntsman Corp.) |
| JEFFAMINE | Triifunctional polyetheramine with average MW |
| T403 | about 440 and only PO groups, CAS No. 39423-51-3, |
| | (obtained from the Huntsman Corp.) |
| JEFFAMINE | Difunctional polyetheramine with average |
| D400 | MW about 400 and only PO groups, CAS |
| | No. 9046-10-0, (obtained from the Huntsman Corp.) |
| JEFFAMINE | Difunctional polyetheramine with average MW |
| D2000 | about 2000 and only PO groups, CAS No. 9046-10-0, |
| | (obtained from the Huntsman Corp.) |
| JEFFAMINE | Difunctional polyetheramine with average MW |
| ED600 | about 600 and PO/EO ratio 3.6/9.0, CAS |
| | No. 65605-36-9, (obtained from the Huntsman Corp.) |
| MEHQ | Hydroquinone monomethyl ether, (obtained from |
| | the Sigma-Aldrich Company, St. Louis, MO) |
| PTZ | Phenothiazine, (obtained from the Sigma-Aldrich Company) |
| SR259 | Polyethylene glycol (200) diacrylate (4 EO units), |
| | CAS No. 26570-48-9, (obtained from Sartomer-Arkema, |
| | Colombes, France) |
| SR344 | Polyethylene glycol (400) diacrylate (9 EO units), |
| | CAS No. 26570-48-9, (obtained from Sartomer-Arkema) |
| SR355 | Ditrimethylolpropane tetraacrylate (DiTMPTTA), CAS |
| | No. 94108-97-1, (obtained from Sartomer-Arkema) |
| SR610 | Polyethylene glycol (600) diacrylate (13 EO units), |
| | CAS No. 26570-48-9, (obtained from Sartomer-Arkema) |
| SR502 | Ethoxylated trimethylolpropane triacrylate (TMPEOTA) |
| | with 9 EO units, CAS No. 28961-43-5, (obtained |
| | from Sartomer-Arkema) |
| SR9035 | Ethoxylated trimethylolpropane triacrylate (TMPEOTA) |
| | with 15 EO units, CAS No. 28961-43-5, (obtained |
| | from Sartomer-Arkema) |
| TMPTA | trimethylolpropane triacrylate, CAS No. 15625-89-5, |
| | (obtained from ECEM, Amsterdam, Netherlands) |
| 1,13 TTD | 4,7,10-trioxatridecane-1,13-diamine, (obtained |
| | from BASF SE) |
| BSA | Benzene sulfonic acid, (obtained from Sigma-Aldrich |
| | Company) |
| DBU | Diazabicycloundecene, (obtained from Sigma-Aldrich |
| | Company) |
| PTSA | para-Toluenesulfonic acid monohydrate |

PO = propylene oxide;
EO = ethylene oxide;
MW = molecular weight (g/mol)

Polyamide Membrane A was prepared according to the procedure described in Example 1 of PCT Patent Application WO2019/005656 (Malek), which is herein incorporated by reference in its entirety.

Polyamide Membrane B was prepared according to the procedure described in Example 1 of U.S. Pat. No. 7,201,860 (Wechs), which is herein incorporated by reference in its entirety.

### Preparatory Example 1 Preparation of the Hydrophilic Monomer PEAA1 (Reaction of TMPTA with JEFFAMINE M2070)

A 100 mL polymerization bottle was charged with TMPTA (7.40 g; 25 mmole), MEHQ (10 mg), PTZ (3 mg) and JEFFAMINE M2070 (25.00 g; 12.5 mmole). The bottle was agitated for 16 hours in a preheated Launder-O-meter machine at 80° C. The resulting product was obtained as a viscous liquid. ¹H and ¹³C NMR spectroscopy peak integration analysis (300 MHZ Avance Digital NMR Spectrometer Bruker, Billerica, MA) was used to determine that the reaction product contained 97% mono-adduct, 3% di-adduct and no residual JEFFAMINE M2070.

### Preparatory Example 2 Preparation of the Hydrophilic Monomers PEAA2-PEAA28

The same procedure as described in Preparatory Example 1 was followed to prepare additional hydrophilic monomers with the exception that different polyetheramine and acrylate components were used. In addition, different molar ratios of polyetheramine and acrylate components (1:2; 1:1.1; 1:3; 1:4, or 1:6 of polyetheramine:acrylate) were used. The components and corresponding molar ratios of the components for preparing the hydrophilic monomers PEAA1-PEAA28 are summarized in Tables 2 and 3.

TABLE 2
Molar Ratios of Components used to Prepare Hydrophilic
Monomers PEAA1-PEAA12, PEAA27, and PEAA28

| | | Polyetheramine Component | | | | | | |
|---|---|---|---|---|---|---|---|---|
| Hydrophilic | Formula | (JEFFAMINE) | | | Acrylate Component | | | |
| Monomer | Type | M1000 | M2070 | ED900 | TMPTA | BDDA | SR502 | SR9035 |
| PEAA1 | (II) | | 1 | | 2 | | | |
| PEAA2 | (II) | 1 | | | 2 | | | |
| PEAA3 | (II) | 1 | | | 1.1 | | | |
| PEAA4 | (II) | | 1 | | 1.1 | | | |
| PEAA5 | (I) | 1 | | | | 2 | | |
| PEAA6 | (II) | 1 | | | | | 2 | |
| PEAA7 | (II) | 1 | | | | | | 2 |
| PEAA8 | (I) | | 1 | | | 2 | | |
| PEAA9 | (II) | | 1 | | | | 2 | |
| PEAA10 | (II) | | 1 | | | | | 2 |
| PEAA11 | (III) | | | 1 | | 4 | | |
| PEAA12 | (I) | | 1 | | | 1.1 | | |
| PEAA27 | (IV) | | | 1 | | | | 4 |
| PEAA28 | (IV) | | | 1 | | | | 6 |

TABLE 3
Molar Ratios of Components used to Prepare
Hydrophilic Monomers PEAA13-PEAA26

| | | Polyetheramine Component | | | | | |
|---|---|---|---|---|---|---|---|
| Hydrophilic | Formula | (JEFFAMINE) | | Acrylate Component | | | |
| Monomer | Type | M2070 | T403 | SR9035 | SR259 | SR344 | SR610 |
| PEAA13 | (I) | 1 | | | 1.1 | | |
| PEAA14 | (I) | 1 | | | 2 | | |
| PEAA15 | (I) | 1 | | | | 1.1 | |
| PEAA16 | (I) | 1 | | | | 2 | |
| PEAA17 | (I) | 1 | | | | | 1.1 |
| PEAA18 | (I) | 1 | | | | | 2 |
| PEAA19 | (V) | | 1 | | 3 | | |
| PEAA20 | (V) | | 1 | | | 3 | |
| PEAA21 | (V) | | 1 | | | | 3 |
| PEAA22 | (VI) | | 1 | 3 | | | |
| PEAA23 | (V) | | 1 | | 6 | | |
| PEAA24 | (V) | | 1 | | | 6 | |
| PEAA25 | (V) | | 1 | | | | 6 |
| PEAA26 | (VI) | | 1 | 6 | | | |

### Preparatory Example 3 Preparation of the Hydrophilic Monomers PEAA29-PEAA37

A 100 mL polymerization bottle was charged with SR259 (40.36 g; 134 mmole), MEHQ (14 mg), PTZ (5 mg) and 1,13 TTD (4.90 g; 22.3 mmole). The bottle was agitated for 16 hours in a preheated Launder-O-meter machine at 80° C. The resulting hydrophilic monomer PEAA34 was obtained as a clear, light yellow semi-viscous liquid.

The same procedure as described PEAA34 was followed to prepare additional hydrophilic monomers with the exception that different acrylate components were used. In addition, two different molar ratios of 1,13 TTD and acrylate components (1:4 or 1:6 of 1,13 TTD:acrylate) were used. The components and corresponding molar ratios of the components for preparing hydrophilic monomers PEAA29-PEAA37 are summarized in Table 4.

TABLE 4
Molar Ratios of Components used to Prepare
Hydrophilic Monomers PEAA29-PEAA37

| | | Polyetheramine | | | | | |
|---|---|---|---|---|---|---|---|
| Hydrophilic | Formula | Component | Acrylate Component | | | | |
| Monomer | Type | 1,13 TTD | SR259 | SR344 | SR610 | SR502 | SR9035 |
| PEAA29 | (VII) | 1 | 4 | | | | |
| PEAA30 | (VII) | 1 | | 4 | | | |
| PEAA31 | (VII) | 1 | | | 4 | | |
| PEAA32 | (VIII) | 1 | | | | 4 | |
| PEAA33 | (VIII) | 1 | | | | | 4 |
| PEAA34 | (VII) | 1 | 6 | | | | |
| PEAA35 | (VII) | 1 | | 6 | | | |
| PEAA36 | (VIII) | 1 | | | | 6 | |
| PEAA37 | (VIII) | 1 | | | | | 6 |

### Preparatory Example 4

A 100 ml reaction bottle was charged with BDDA (15.59 g; 79 mmole), MEHQ (25 mg), PTZ (10 mg), JEFFAMINE M1000 (35.00 g; 35.8 mmole) and BSA (1.52 g). The reaction bottle was agitated for 24 hours in a preheated Launder-O-meter machine at 90° C. The resulting hydrophilic monomer PEAA38 was obtained as a clear, brown, semi-viscous liquid (Formula (IX)). NMR spectroscopy analysis was used to determine that the reaction product contained 70% of the di-adduct and 30% of the mono-adduct.

### Preparatory Example 5

A 100 mL reaction bottle was charged with SR259 (20.38 g), MEHQ (25 mg), PTZ (10 mg), JEFFAMINE M1000 (30.00 g) and BSA (1.51 g). The reaction bottle was agitated for 24 hours in a preheated Launder-O-meter machine at 90° C. The resulting hydrophilic monomer PEAA39 was obtained (Formula (IX)). NMR spectroscopy analysis was used to determine that the reaction product contained 68% of the di-adduct and 32% of the mono-adduct.

### Preparatory Example 6

The general procedure of previous preparatory examples was followed using a 100 mL polymerization bottle charged with TMPTA (10.09 g), MEHQ (12 mg), PTZ (4 mg), JEFFAMINE M2070 (31 g), and PTSA (0.41 g). The resulting hydrophilic monomer PEAA40 was obtained (Formula (X)). NMR spectroscopy analysis was used to determine that the reaction product contained 84% of the di-adduct and 16% of the mono-adduct.

### Preparatory Example 7

The general procedure of previous preparatory examples was followed using a 100 mL polymerization bottle charged with TMPTA (10.09 g), MEHQ (12 mg), PTZ (4 mg), JEFFAMINE M2070 (31 g), and BSA (0.41 g). The resulting hydrophilic monomer PEAA41 was obtained (Formula (X)). NMR spectroscopy analysis was used to determine that the reaction product contained 91% of the di-adduct and 9% of the mono-adduct.

### Preparatory Example 8

The general procedure of previous preparatory examples was followed using a 100 mL polymerization bottle charged with TMPTA (10.09 g), MEHQ (12 mg), PTZ (4 mg), JEFFAMINE M2070 (31 g), and DBU (0.41 g). The resulting hydrophilic monomer PEAA42 was obtained (Formula (X)). NMR spectroscopy analysis was used to determine that the reaction product contained 75% of the di-adduct and 25% of the mono-adduct.

### Preparatory Example 9

The general procedure of previous preparatory examples was followed using a 100 mL polymerization bottle charged with SR259 (41.18 g), MEHQ (25 mg), PTZ (10 mg), JEFFAMINE ED600 (9 g), and BSA (1.51 g). The resulting hydrophilic monomer PEAA43 was obtained (Formula (XI)).

### Preparatory Example 10

The general procedure of previous preparatory examples was followed using a 100 mL polymerization bottle charged with SR259 (35.52 g), MEHQ (25 mg), PTZ (10 mg), JEFFAMINE ED900 (14.7 g), and BSA (1.52 g). The resulting hydrophilic monomer PEAA44 was obtained (Formula (XI)).

### Preparatory Example 11

The general procedure of previous preparatory examples was followed using a 100 mL polymerization bottle charged with TMPTA (41.26 g), MEHQ (25 mg), PTZ (10 mg), JEFFAMINE ED600 (9.20 g), and BSA (1.51 g). The resulting hydrophilic monomer PEAA45 was obtained (Formula (XII)).

### Preparatory Example 12

The general procedure of previous preparatory examples was followed using a 100 ml polymerization bottle charged with TMPTA (35.52 g), MEHQ (25 mg), PTZ (10 mg), JEFFAMINE ED900 (15.0 g), and BSA (1.52 g). The resulting hydrophilic monomer PEAA46 was obtained (Formula (XII)).

### Example 1 E-Beam Grafting of PEAA4 Monomer Onto a Polyamide Membrane

E-beam irradiation grafting was conducted using an ESI CB-300 down fire e-beam system (Energy Sciences, Incorporated, Wilmington, MA). A sample of Polyamide A was cut into an 18 cm×25.4 cm piece and stored in a polyethylene bag. The general procedure for sample surface modification is described as follows. A monomer solution having a PEAA4 monomer concentration of about 1% was prepared by dissolving the required amount of monomer in deionized water and then degassing the solution with nitrogen. The dry membrane was purged with nitrogen in a glovebox to inert the sample prior to e-beam irradiation. The degassed monomer solution was also stored in the inerted glove box. The polyethylene bag was opened and monomer solution (11.5 mL) was added to the bag so that the membrane was immersed in the monomer solution. The bag was sealed and the solution was distributed using a hand roller so that the membrane sample was uniformly covered with the solution. Next, the membrane in the bag was irradiated by the electron-beam process (dose=50 kGy). The resulting grafted membrane was then washed by immersing the membrane in deionized water for 15 minutes. The wash procedure was repeated two times using fresh deionized water for each wash step. The washed membrane was dried in an oven for 60 minutes at 100° C., cooled to ambient temperature, and then stored in a polyethylene bag. The finished grafted membrane had a percent weight gain of 7.7±1.7%.

### Example 2 E-Beam Grafting of PEAA4 Monomer Onto a Polyamide Membrane

The same procedure as described in Example 1 was followed with the exception that the monomer solution had a higher PEAA4 monomer concentration of 3%. The finished grafted membrane had a percent weight gain of 12.6±0.1%.

### Example 3 E-Beam Grafting of PEAA4 Monomer Onto a Polyamide Membrane

The same procedure as described in Example 1 was followed with the exception that the Polyamide Membrane A was replaced with Polyamide Membrane B. The finished grafted membrane had a percent weight gain of 7.2±0.2%.

### Example 4 E-Beam Grafting of PEAA4 Monomer Onto a Polyamide Membrane

The same procedure as described in Example 1 was followed with the exception that the Polyamide Membrane A was replaced with Polyamide Membrane B and the monomer solution had a higher PEAA4 monomer concentration of 3%. The finished grafted membrane had a percent weight gain of 12.6±1.0%.

### Example 5 E-Beam Grafting of PEAA4 Monomer Onto an Ultra-High-Molecular-Weight Polyethylene (UHMWPE) Membrane

E-beam irradiation grafting was conducted using an ESI CB-300 down fire e-beam system (Energy Sciences, Incorporated). The UHMWPE membrane sample was cut into an 18 cm×25.4 cm piece and stored in a polyethylene bag. The general procedure for sample surface modification is described as follows. A monomer solution having a PEAA4 monomer concentration of about 5% was prepared by dissolving the required amount of monomer in deionized water and then degassing the solution with nitrogen. The dry membrane was purged with nitrogen in a glovebox to inert the sample prior to e-beam irradiation. The degassed monomer solution was also stored in the inerted glove box. The polyethylene bag was opened and monomer solution (11.5 mL) was added to the bag so that the membrane was immersed in the monomer solution. The bag was sealed and the solution was distributed using a hand roller so that the membrane sample was uniformly covered with the solution. Next, the membrane in the bag was irradiated by the electron-beam process (dose=50 kGy). The resulting grafted membrane was then washed by immersing the membrane in deionized water for 15 minutes. The wash procedure was repeated two times using fresh deionized water for each wash step. The washed membrane was dried in an oven for 60 minutes at 100° C., cooled to ambient temperature, and then stored in a polyethylene bag. The finished grafted membrane had a percent weight gain of 4.0±0.1%.

### Example 6

The results for analyzing the grafted membranes of Examples 1-5 according to the “Static Protein Binding Assay with IgG” and the “Transmembrane Flow (TMF) Assay” (described above) are reported in Tables 5-7. The IgG binding results are reported as the mean value calculated from five separate tests (n=5) and the TMF results are reported as the mean value calculated from two separate tests (n=2). For Comparative Example A, samples of Polyamide Membrane A that were not submitted to the grafting procedure of Example 1 were analyzed. For Comparative Example B, samples of the Polyamide Membrane B that were not submitted to the grafting procedure of Example 3 were analyzed. For Comparative Example C, samples of the UHMWPE membrane that were not submitted to the grafting procedure of Example 5 were analyzed.

Prior to analysis, each membrane of Comparative Examples A-C was washed by immersing the membrane in deionized water for 15 minutes. Fresh deionized water was used for each wash step. Each washed membrane was dried in an oven for 60 minutes at 100° C. and then cooled to ambient temperature.

TABLE 5

| | | Monomer | Amount of IgG Bound | |
|---|---|---|---|---|
| Membrane | Membrane | Concentration in | to Membrane | TMF using Water |
| Example | Type | Grafting Solution | (micrograms/cm²) | [mL/(min*m²*bar] |
| Example 1 | polyamide | 1% | 44.8 ± 0.8 | 0.9 ± 0.3 |
| Example 2 | polyamide | 3% | 20.7 ± 0.4 | 1.3 ± 0.1 |
| Comparative | polyamide | not grafted | 164.8 ± 1.2 | 2.5 ± 0.1 |
| Example A | | | | |

TABLE 6

| | | Monomer | Amount of IgG Bound | |
|---|---|---|---|---|
| Membrane | Membrane | Concentration in | to Membrane | TMF using Water |
| Example | Type | Grafting Solution | (micrograms/cm²) | [mL/(min*m²*bar] |
| Example 3 | polyamide | 1% | 48.3 ± 1.1 | 1.6 ± 0.1 |
| Example 4 | polyamide | 3% | 15.5 ± 0.7 | 1.1 ± 0.2 |
| Comparative | polyamide | not grafted | 132.9 ± 3.2 | 2.5 ± 0.1 |
| Example B | | | | |

TABLE 7

| | | Monomer | Amount of IgG Bound | |
|---|---|---|---|---|
| Membrane | Membrane | Concentration in | to Membrane | TMF using IPA |
| Example | Type | Grafting Solution | (micrograms/cm²) | [mL/(min*m²*bar] |
| Example 5 | UHMWPE | 5% | 169.1 ± 30.0 | 125.1 ± 6.3 |
| Comparative | UHMWPE | not grafted | 151.0 ± 2.1 | 102.3 ± 1.7 |
| Example C | | | | |

### Example 7

Zeta-potential measurements for the grafted membranes of Examples 1-5 and the corresponding Comparative Examples A-C were conducted according to the test method “Zeta-potential Measurement” described above in the Test Method Section. The results are reported in Tables 8-10. The grafted polyamide membranes of Examples 1-4 had measured isoelectric points at a lower pH range (pH 6-8) than for the corresponding ungrafted polyamide membranes (Comparative Examples A and B). The grafted UHMWPE membrane of Example 5 had a measured isoelectric point at a higher pH range (pH 6-7) than for the corresponding ungrafted UHMWPE membrane (Comparative Example C).

TABLE 8

| | Zeta-Potential Data [mV] | | |
|---|---|---|---|
| | Comparative | | |
| | Example A | Example 1 | Example 2 |
| pH | Membrane | Membrane | Membrane |
| 3 | 133 | 91 | 80 |
| 4 | 120 | 70 | 59 |
| 5 | 105 | 54 | 35 |
| 6 | 83 | 40 | 3 |
| 7 | 70 | 20 | −28 |
| 8 | 51 | −3.5 | −60 |

TABLE 9

| | Zeta-Potential Data [mV] | | |
|---|---|---|---|
| | Comparative | | |
| | Example B | Example 3 | Example 4 |
| pH | Membrane | Membrane | Membrane |
| 3 | 125 | 60 | 70 |
| 4 | 112 | 50 | 62 |
| 5 | 95 | 40 | 41 |
| 6 | 72 | 30 | 18 |
| 7 | 60 | 18 | −5 |
| 8 | 40 | −7 | −20 |

TABLE 10

Zeta-Potential Data [mV]

| | Comparative | |
|---|---|---|
| | Example C | Example 5 |
| pH | Membrane | Membrane |
| 3 | 24 | 44 |
| 4 | 8 | 34 |
| 5 | −13 | 21 |
| 6 | −25 | 10 |
| 7 | −42 | −12 |
| 8 | −52 | −31 |

All references and publications cited herein are expressly incorporated herein by reference in their entirety into this disclosure. Illustrative embodiments of this invention are discussed and reference has been made to possible variations within the scope of this invention. For example, features depicted in connection with one illustrative embodiment may be used in connection with other embodiments of the invention. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof.

1. A polymeric membrane, comprising a modified surface obtained from coating with hydrophilic monomers and curing the hydrophilic monomers with electron beam,
wherein the polymeric membrane is selected from polyamide membranes, polytetrafluoroethylene membranes, polymethylpentene membranes and Ultra-high-molecular-weight polyethylene (UHMWPE) membranes; and
wherein the hydrophilic monomers comprise
(i) at least one amino moiety;
(ii) at least one polyoxyalkylene unit; and
(iii) at least one (meth)acrylate moiety.

2. The polymeric membrane of claim 1, wherein the at least one polyoxyalkylene unit of the hydrophilic monomer is selected from polyethers.

3. The polymeric membrane of claim 1, wherein the at least one amino moiety of the hydrophilic monomer is at least one secondary amino moiety and/or at least one tertiary amino moiety.

4. The polymeric membrane of claim 1, wherein the monomer comprises one secondary amino moiety, two secondary amino moieties, three secondary amino moieties, or four secondary amino moieties.

5. The polymeric membrane claim 1, wherein the monomer comprises one tertiary amino moiety, two tertiary amino moieties, three tertiary amino moieties, or four tertiary amino moieties.

6. The polymeric membrane of claim 1, wherein the hydrophilic monomer comprises acrylate moieties in an amount of from 1 to 10.

7. The polymeric membrane of claim 1, wherein the adsorption of IgG to the surface of the membrane is lower than 150 μg/cm².

8. A method, the method comprising:
(I) providing a polymeric membrane selected from polyamide membranes, polytetrafluoroethylene membranes, polymethylpentene membranes and Ultra-high-molecular-weight polyethylene (UHMWPE) membranes;
(II) applying a solution comprising hydrophilic monomers to the polymeric membrane; and
(III) irradiating the polymeric membrane with electron beam,
wherein the hydrophilic monomers comprise
(i) at least one amino moiety;
(ii) at least one polyoxyalkylene unit; and
(iii) at least one (meth)acrylate moiety.

9. The method of claim 8, wherein irradiating with actinic radiation is carried out an irradiation dose of a mean value in the range of from 10 to 300 kGy.

10. The method of claim 8, wherein the polymeric membrane is selected from hollow-fiber membranes and flat-sheet membranes.

11. The method of claim 8, further comprising subjecting the membrane obtained in step (III) to an extracting step.

12. The method of claim 8, further comprising drying the membrane.

13. A use of the polymeric membrane of claim 1, for water purification, filtration in the production of food, filtration in the production of beverages, filtration in the electronics industry, medical filtration or filtration in the biopharmaceutical industry.
